(19) United States
(12) Patent Application Publication
(10) Pub. No.: US 2022/0044198 A1
(43) Pub. Date: Feb. 10, 2022

(54) METHOD AND APPARATUS FOR DYNAMIC LOAD SELECTION AND PARKING CALCULATION FOR LAST MILE DELIVERY

(71) Applicant: HERE Global B.V., Eindhoven (NL)

(72) Inventor: Joachim MEISTER, Berlin (DE)

(21) Appl. No.: 17/111,205

(22) Filed: Dec. 3, 2020

Related U.S. Application Data
(60) Provisional application No. 63/063,759, filed on Aug. 10, 2020.

(51) Int. Cl. G06Q 10/08

(52) U.S. Cl. CPC G06Q 10/08355; G06Q 10/0838; G06Q 10/0833

(57) ABSTRACT

An approach is provided for providing a dynamic parking and package delivery load recommendation based on on-site parking availability and delivery capability attributes of a delivery means (e.g., a deliver person) of a delivery vehicle. The approach involves determining a stopping location associated with a delivery vehicle. The delivery vehicle carries a plurality of delivery items. The approach also involves determining a subset of the plurality of delivery items to be delivered from the stopping location by a delivery means of the delivery vehicle in a load based, at least in part, on one or more delivery capability attributes of the delivery means. The subset of the plurality of delivery items is determined dynamically based on detecting that the delivery vehicle has stopped at the stopping location. The approach further involves providing data for presenting or transmitting the subset of the plurality of delivery items as an output.

### RELATED APPLICATION

This application claims priority from U.S. Provisional Application Ser. No. 63/063,759, entitled “METHOD AND APPARATUS FOR DYNAMIC LOAD SELECTION AND PARKING CALCULATION FOR LAST MILE DELIVERY,” filed on Aug. 10, 2020, the contents of which are hereby incorporated herein in their entirety by this reference.

### BACKGROUND

Last mile delivery of goods to customers (e.g., delivery of goods from a nearest delivery transportation hub to the final destination) presents significant technical challenges to delivery and logistics service providers. This is because conditions on the last mile delivery route (e.g., available parking at the delivery location, traffic, weather, etc.) are dynamic and can affect where, when, and how deliveries can be made. Historically, delivery services have relied on highly experienced drivers familiar with existing delivery routes to make logistical delivery decisions based on dynamic conditions at the time of delivery (e.g., where to stop, how long to stop, what packages to deliver from a certain stop on the route, etc.), thereby placing a significant cognitive burden on delivery drivers. Accordingly, service providers are continually challenged to find technical solutions that can make automated and dynamic delivery decisions to improve the efficiency of last mile delivery.

### SOME EXAMPLE EMBODIMENTS

Therefore, there is a need for an approach for providing dynamic parking and package delivery load recommendations (e.g., what packages to pick from the delivery truck to deliver from each stop along a last mile delivery route) based on on-site parking availability and attributes (e.g., attributes related to delivery capabilities such as carrying capacity, range, etc.) of the delivery personnel (e.g., drivers) and/or other delivery means (e.g., delivery drones).

According to one embodiment, a method comprises determining a stopping location associated with a delivery vehicle. The delivery vehicle carries a plurality of delivery items. The method also comprises determining a subset of the plurality of delivery items to be delivered from the stopping location by a delivery means of the delivery vehicle in a load based, at least in part, on one or more delivery capability attributes of the delivery means. The subset of the plurality of delivery items is determined dynamically based on detecting that the delivery vehicle has stopped at the stopping location. The method further comprises providing data for presenting or transmitting the subset of the plurality of delivery items as an output.

According to another embodiment, an apparatus comprises at least one processor, and at least one memory including computer program code for one or more computer programs, the at least one memory and the computer program code configured to, with the at least one processor, cause, at least in part, the apparatus to determine a stopping location associated with a delivery vehicle. The delivery vehicle carries a plurality of delivery items. The apparatus also is caused to determine a subset of the plurality of delivery items to be delivered from the stopping location by a delivery means of the delivery vehicle in a load based, at least in part, on one or more delivery capability attributes of the delivery means. The subset of the plurality of delivery items is determined dynamically based on detecting that the delivery vehicle has stopped at the stopping location. The apparatus further is caused to provide data for presenting or transmitting the subset of the plurality of delivery items as an output.

According to another embodiment, a non-transitory computer-readable storage medium carries one or more sequences of one or more instructions which, when executed by one or more processors, cause, at least in part, an apparatus to determine a stopping location associated with a delivery vehicle. The delivery vehicle carries a plurality of delivery items. The apparatus also is caused to determine a subset of the plurality of delivery items to be delivered from the stopping location by a delivery means of the delivery vehicle in a load based, at least in part, on one or more delivery capability attributes of the delivery means. The subset of the plurality of delivery items is determined dynamically based on detecting that the delivery vehicle has stopped at the stopping location. The apparatus further is caused to provide data for presenting or transmitting the subset of the plurality of delivery items as an output.

According to another embodiment, an apparatus comprises means for determining a stopping location associated with a delivery vehicle. The delivery vehicle carries a plurality of delivery items. The apparatus also comprises means for determining a subset of the plurality of delivery items to be delivered from the stopping location by a delivery means of the delivery vehicle in a load based, at least in part, on one or more delivery capability attributes of the delivery means. The subset of the plurality of delivery items is determined dynamically based on detecting that the delivery vehicle has stopped at the stopping location. The apparatus further comprises means for providing data for presenting or transmitting the subset of the plurality of delivery items as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for providing a dynamic parking and/or package delivery load recommendation for last mile delivery, according to one embodiment;

FIG. 2 is a diagram of the components of a delivery platform, according to one embodiment;

FIG. 3 is a diagram of a process for providing a dynamic parking and package delivery load recommendation for last mile delivery, according to one embodiment;

FIGS. 4A-4E are diagrams of example navigation user interfaces presenting parking options and delivery load scenarios, according to various embodiments;

FIGS. 5A-5C are diagrams of example navigation user interfaces prompting delivery means capability updates for generating a parking and load recommendation, according to various embodiments;

FIG. 6 is a diagram of a geographic database, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., mobile computer or vehicle or part thereof) that can be used to implement an embodiment.

### DESCRIPTION OF SOME EMBODIMENTS

Examples of a method, apparatus, and computer program for providing dynamic load selection and parking calculation for last mile delivery are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

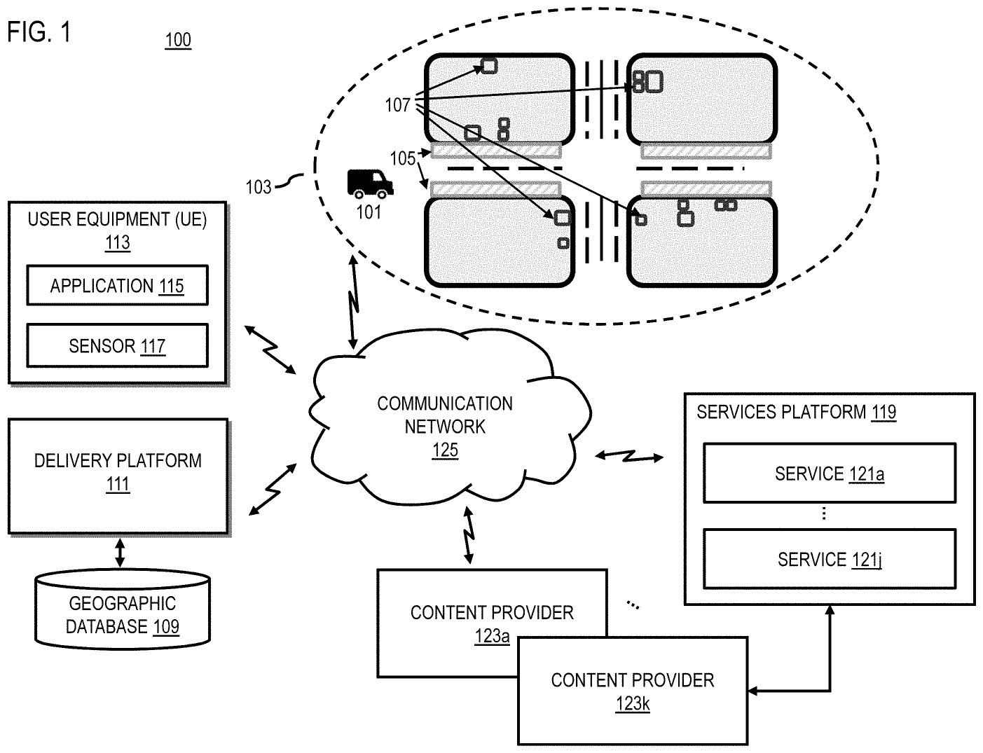

FIG. 1 is a diagram of a system for providing a dynamic load selection and/or parking recommendation for last mile delivery, according to one embodiment. As used herein, the term “last mile delivery” refers to the transportation of goods from a transportation hub to a final destination (e.g., a customer's home or business). In other words, a “last mile delivery” is typically the last leg of a delivery route that a delivery service uses to transport goods from its origin to a final destination. By way of example, a delivery service will often establish transportation hubs along delivery routes near its customers so that goods can be collected at origin transportation hubs for more efficient mass transport to destination transportation hubs. The collection and aggregation of goods for mass transport enables the delivery service to use larger transportation means (e.g., cargo planes, trains, larger cargo trucks, etc.) that are more efficient and cost effective for transporting goods between transportation hubs. Then when goods reach the destination transportation hub, the delivery service can switch to smaller delivery vehicles (e.g., a delivery vehicle 101 such as but not limited to smaller trucks, vans, delivery drones, robots, etc.) for last mile delivery to the final destination. This last mile delivery is often performed by smaller vehicles because they can more efficiently travel to multiple final destinations that vary with the goods (as opposed to traveling on routes between fixed transportation hubs).

Because of its variable and dynamic nature, delivering goods on a last mile delivery traditionally involves constant decision making by a human driver: e.g., (1) balancing where to stop to not disturb other traffic on the one hand and being close to the recipients on the other; (2) determining how much to load at once during a stop depending on the size, weight, amount, etc. of the goods or packages to be delivered; (3) determining where to stop again along the last mile delivery route to efficiently deliver goods; and (4) if a previously recommended or used stopping location is blocked or unavailable, determining where to stop then and what goods to deliver at this point.

For example, looking for parking (e.g., on-street parking) where a delivery vehicle 101 can park to deliver goods, particularly in urban or congested areas, can be stressful and difficult for commercial vehicle drivers, such as a delivery vehicle driver. This is because stopping locations and corresponding loads to carry at each stopping location can vary dynamically based on where the delivery vehicle 101 actually stops. These actual stopping locations can be highly unpredictable because of ever changing parking availability, parking restrictions, congestion, and/or other dynamic conditions faced by delivery drivers. As a result, efficient decision making on the driver's part often requires extensive personal experience and knowledge of a delivery. Thus when such driver experience or knowledge is limited (e.g., new drivers, existing drivers covering new routes, etc.), delivery efficiency (e.g., the time and/or distance needed to make a delivery) can be affected. Even when such experience and/or knowledge exists, the cognitive load on delivery drivers to make these decisions can also affect delivery efficiency. As a result, service providers face significant technical challenges to providing for more efficient last mile delivery while also reducing the cognitive load on drivers.

To address these technical challenges, a system 100 of FIG. 1 introduces a capability to automatically determine where a delivery vehicle 101 should stop on a last mile delivery route and what items (e.g., goods, packages, etc.) that have been loaded on the vehicle 101 (e.g., loaded at a delivery service transportation hub) should be picked and loaded for delivery per stop (e.g., to be as efficient as possible—in terms of minimized delivery time, delivery distance, number of stops, etc.). In one embodiment, the system 100 uses a dynamic algorithm to take variables (e.g., variables related to location data, item/goods data, historical data on recipient availability and/or preferences, driver/delivery means capability data, etc.) into account in order to calculate an optimized last mile delivery solution. For example, the solution can output data indicating recommended stopping/parking location(s) for a vehicle 101 on a last mile delivery route and corresponding items to pick from cargo of the vehicle 101 at individual stopping/parking locations. The system 100 calculates, for instance, the best stopping/parking spot for a last mile delivery based on a combination of available data about the streets, the items to deliver, the capability of the driver or other delivery means (e.g., delivery drone capability), and/or the like. In one embodiment, if the driver can stop at the recommended spot, the system 100 presents a list of items (e.g., selected from the items loaded in the vehicle 101) that the driver or other delivery means needs to deliver from that spot.

In another embodiment, the system 100 can dynamically recommend where to stop when an initially recommended stopping location becomes taken/unavailable, and what packages to load and deliver from the newly recommend spot. The system 100 can determine the best stopping location in an area 103 and what delivery items to load and ship delivery items per stop as efficient as possible, by using an algorithm that dynamically takes many variables into account, such as delivery location data, parking data, delivery item data, driver capability data, etc., to calculate for a last mile delivery load. In one embodiment, the system 100 can calculate the best stopping location for a vehicle 101 (e.g., a delivery vehicle) approaching the area 103. The area 103 may span any geographic boundary (e.g., neighborhoods, cities, regions, etc.) of interest and may include a variety of road links and/or parking locations. By way of example, the area 103 includes parking locations 105 and designated delivery locations of a plurality delivery items 107 (e. g. , packages).

In one embodiment, the system 100 can collect availability data from delivery recipients and plan the delivery accordingly. In another embodiment, the system 100 can use historical or other data about the recipients to predict the recipient availability and to make a recommendation as to where the delivery vehicle 101 is to stop and/or what items to pick for a delivery. For example, if historical data indicates that a recipient is not usually available to receive packages at a time at which the vehicle 101 is expected to be in the area, the system 100 may recommend that the item that is to be delivered to the recipient not be picked at that location and/or time. This is because if the driver were to pick the item to carry to the recipient's address, it is likely that the recipient would not be able to accept the package and the driver would have to carry the package back to the vehicle 101 if the recipient has not approved leaving the package unattended. In yet another embodiment, the historical availability of the recipient can be used to determine or calculate the last mile delivery route so that the vehicle 101 reaches the vicinity of the recipient at a time when the recipient is predicted to be home to receive packages/items/goods. In this way, the last mile delivery route can be optimized to avoid unnecessarily having to carry goods that cannot be delivered. In yet another embodiment, the recipient's historical availability data can be used to predict where the recipient will be at the time of expected delivery and then recommend a last mile delivery stopping location and load list based on the prediction. For example, if historical data indicates that a recipient is normally available at the delivery location between 9 am and 5 pm and unavailable at the delivery location after 5 pm, then the system 100 can recommend that a stopping location and load list so that the last mile delivery attempts delivery of the recipient's goods at the delivery location between 9 am and 5 pm and/or at a secondary delivery location after 5 pm if available.

As used herein, the term “vehicle” refers to is a mode of transport for transporting cargo and/or people, such as motor vehicles (e.g., cars, trucks, buses, motorcycles, etc.), bicycles, tricycles, railed vehicles (e.g., trains, trams, etc.), watercraft (e.g., ships, boats, etc.), aerial vehicles (e.g., airplanes, helicopters, drones, etc.), etc.

As used herein, the term “stopping location” refers to a location that has been used for parking a vehicle, either designated or undesignated for vehicle parking/standing/stopping, either paved or unpaved. It can be in a parking garage, in a parking lot or on a private or public street, over a bicycle lane, sidewalk, grass verges or other places which are not designed for vehicle parking/standing/stopping, etc. The stopping location may or may not be delineated by road surface markings. The vehicle fits inside the stopping location, by parallel parking, perpendicular parking, angled parking, etc. Although various embodiments are described with respect to land/terrestrial vehicles, it is contemplated that the approach described herein may be used with other vehicles, such as watercraft, aerial vehicles, drones, etc. Moreover, the term “stopping location” is used interchangeably with “parking location” in the embodiments described herein.

As used herein, the term “dynamic parking and package delivery load recommendation” refers to a recommendation of a stopping location and a list of delivery items to be delivered from the stopping location. A driver should be able to park, stop, stand, etc. the vehicle at the stopping location for a designated period of time (e.g., 15 minutes, 30 minutes, etc.) and/or for a duration to deliver (pickup/drop off) a list of delivery items.

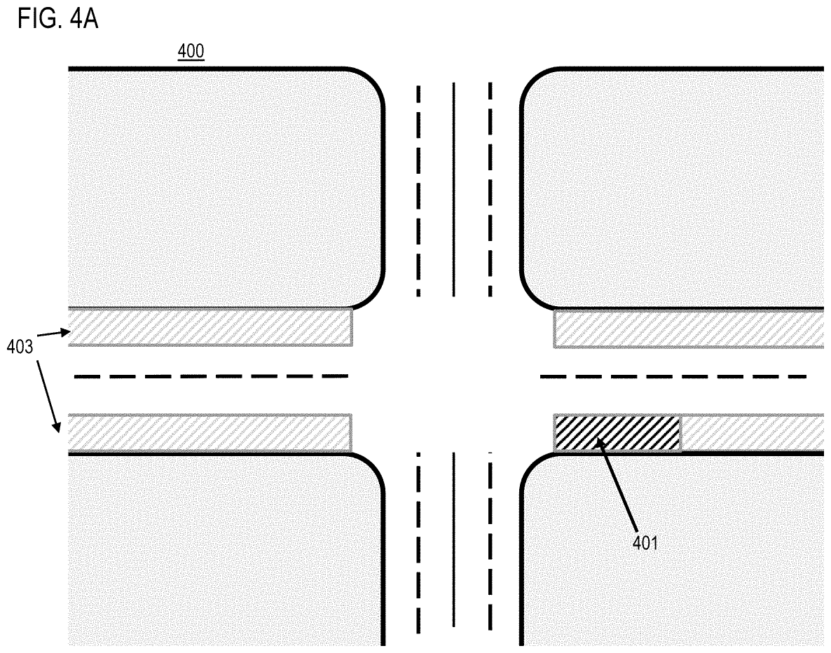

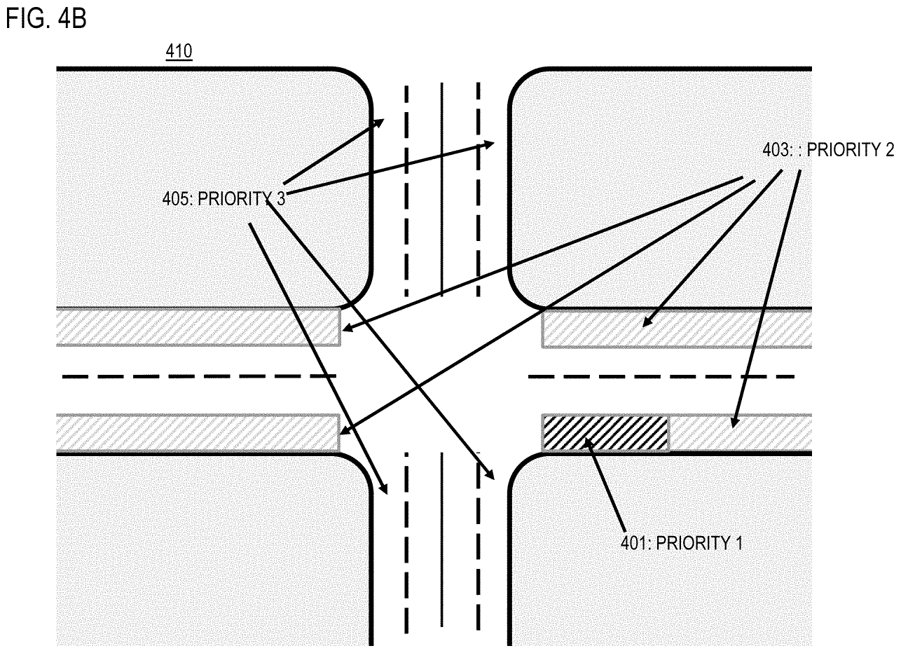

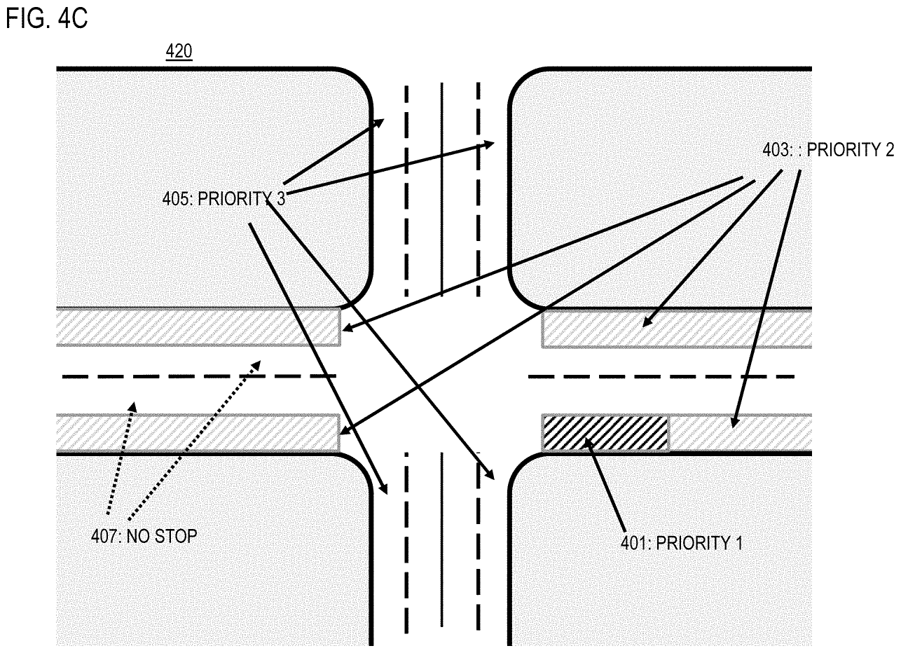

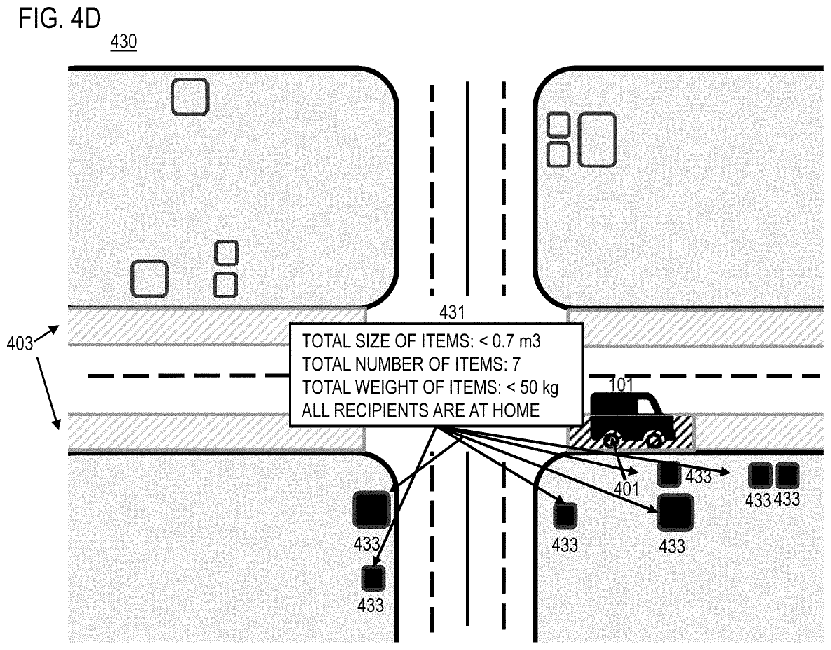

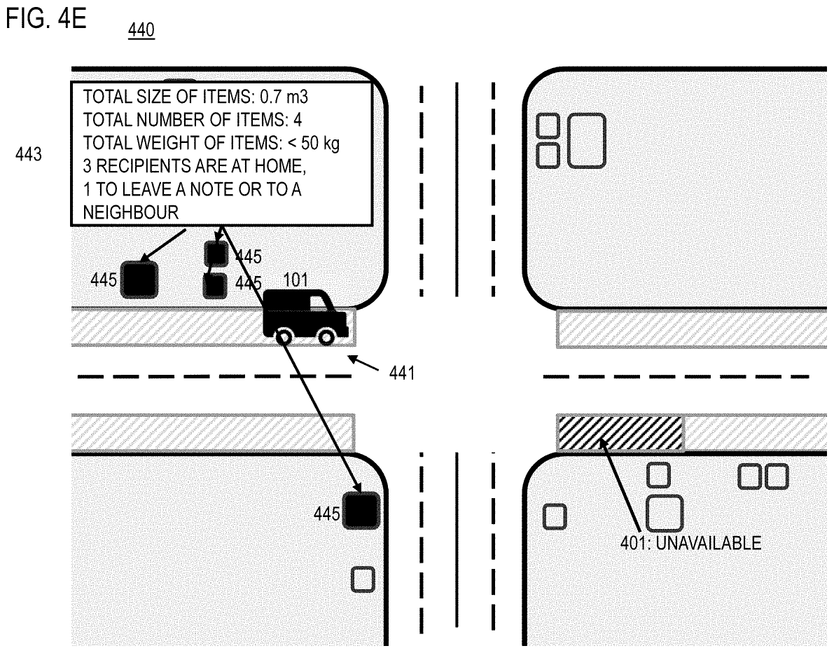

In one embodiment, the user can adjust a zoom level of the area 103, and the respective parking locations 105 and the respective designated delivery locations of delivery items 107 (e.g., packages) change accordingly. In addition, the user can select to display (1) all of the delivery items 107 in the area 103 without highlighting selected delivery items for a stopping location (e.g., FIG. 1), (2) all of the delivery items 107 in the area 103 with the selected delivery items highlighted for a stopping location (e.g., FIGS. 4D-4E), (3) only the selected delivery items for the stopping location, etc.

In another embodiment, the user can select to display all delivery items in the vehicle 101 regardless of the area 103, as they vary dynamically during the day of the delivery trip. Meanwhile, the system 100 can highlight, mark, and/or sort the items automatically for the delivery driver to easily identify, grab, and load them without scanning labels.

By way of example, in the embodiment shown in FIG. 1, the delivery items 107 can be presented or represented in a user interface using any shape (e.g., circle, square, thumbnails, etc.) and sizes (e.g., in proportion with respective weights and/or dimensions of the items) to better visualize the delivery items 107, thereby identifying and/or loading the delivery items 107 with respect to their designated delivery locations.

Due to the highly dynamic nature of parking occupancy of relevant parking locations 105 and/or mobility patterns of vehicles in the area 103, the system 100 can gather and process static and dynamic data sets (e.g., including delivery location data, parking location attributes, vehicle attributes, delivery item attributes, driver/passenger attributes, traffic attributes, weather attributes, etc.) to find the best stopping location (e.g., a temporary parking location which is close to designated locations of the delivery items 107 while satisfying other delivery attributes, such as a delivery time frame, etc.). In one embodiment, a best stopping location can be calculated for the vehicle 101 (e.g., a delivery vehicle, a ride hailing vehicle, a private car, etc.) and/or personalized for a driver of the vehicle 101 (such as weight and size limits, etc.). Various embodiments of the process are described below.

For instance, when a driver of the vehicle 101 can park at the best stopping location (i.e., an initially recommend stopping location), the system 100 can present a list of delivery items for the driver to load and deliver from the best stopping location. As another instance, when the best stopping location is taken/unavailable, the system 100 can calculate a newly recommended stopping location (e.g., the second best stopping location in the area 103) and which items to load and deliver from the newly recommended stopping location. As such, the system 100 can support a delivery driver to think less about where to stop and what to load, and to concentrate more on other aspects of delivery, such as driving the vehicle 101, interacting with customers, etc. The system 100 thus can reduce driver decision making and save delivery time.

In one example use case, the area 103 can be defined based on a designated radius from a current location of the vehicle 101 to delivery to the designated locations of the plurality delivery items 107 within the area 103. In other use cases, the vehicle 101 can be any vehicle that is searching for a temporary parking location (e.g., a shared vehicle or taxi) that is dropping off and/or picking up passengers and/or luggage. In one embodiment, a temporary parking location is a location anywhere within the area 103 at which the vehicle 101 can temporarily park, stop, or stand for less than a designated period of time or a duration of a limited purpose (e.g., time needed to make a delivery, pick up/drop off a passenger, etc.).

In one embodiment, the system 100 can determine the best parking spot as taken by another vehicle or otherwise unavailable (e.g., blocked by public authority for road work, etc.) via computer visioning. In another embodiment, the system 100 can determine the best parking spot as taken by another vehicle or otherwise unavailable via real-time probe data analysis, such as vehicle probe data, user device probe data, etc. In yet another embodiment, the driver can determine the best parking spot as taken by another vehicle or otherwise unavailable.

As mentioned, when the best parking spot is taken by another vehicle or otherwise unavailable, the system 100 can recommend the second best location to temporarily park. In one embodiment, the system 100 selects the second best location based on the original processing. In another embodiment, the system 100 can re-calculate a new best parking spot using the algorithm that factors in updated delivery location data, parking data, delivery item data, driver capability data, etc., to efficiently delivery a set of delivery items carried by the vehicle 101.

In other words, the system 100 supports dynamic parking via finding available target stopping locations in range, depending on historical data, from other drivers, temporary stopping locations, parking facilities, Loading zones, street width (number of lanes for 2nd row parking), etc. In addition, the system 100 supports dynamic loading via searching for destinations among parcel recipients and types of delivery items, depending on data of weight and size, availability and timeframe, historical availability (normally at home at this time), live availability (e.g., smart phone locating data), opening hours, distances between recipients for the selected delivery items (e.g. floors in buildings), etc. The system 100 then determines ideal stopping locations and recommend alternatives as necessary (as discussed). Each spot has its own travelling salesman route for a walking distance and a timeframe. The system 100 can calculate alternative parking such that the driver can spend as less time and walking distance as possible. The system 100 calculates the best stopping location based on the combination of all available attribute data about the delivery items, the driver, the recipients (e.g., recipient availability), the delivery locations, the vehicle, etc. If the driver can stop at the best spot, the system presents the list of items for the driver to deliver. If the best spot is unavailable, the system 10 calculates the next best stopping location and a new list of items to deliver therefrom.

In another embodiment, the system 100 can combine various static and dynamic location based sensor data to train a dynamic parking and package delivery load recommendation model (e.g., a machine learning model) in order to generate a model which minimizes the delivery time for the vehicle 101 and/or the driver. The system 100 then recommends the best stopping location and a respective delivery item list based on the following attributes.

The static and dynamic location based sensor data may include delivery item attributes (e.g., weights, sizes, delivery locations, delivery time frames, signature requirements, etc. of items to be picked-up/dropped-off), driver attributes (e.g., load limits in terms of weights/sizes, area familiarity, delivery experience, work schedules, etc. of a driver), recipient attributes (e.g., availability data, alternate delivery locations, etc. of a delivery item recipient), delivery location attributes (e.g., operation/concierge hours, entry/exit/loading locations, ramps, stairs, elevators, distances to stopping locations, etc. associated with delivery locations), passenger attributes (e.g., preference data, with special needs or not, etc.), vehicle attributes (e.g., models, weights, sizes, delivery aids or not, maneuverability, origins/destinations, mobility graphs, etc. of the vehicle 101), parking location attributes (e.g., designated or not, paved or not, parking restrictions (e.g., handicapped parking spaces, emergency infrastructure including fire hydrants, temporary event parking limits including street fairs, festival, etc.), fee or free, churn rates, occupancy patterns, etc.), road attributes (e.g., road dimensions, shapes, directionality, lane attributes, traffic of road links near delivery locations), weather attributes (e.g., line of sight/visibility, surface slippery or not, etc.), population density, etc.

In one embodiment, the static and dynamic location based sensor data may be retrieved from various local and/or external databases. By way of example, the system 100 can obtain the delivery location attributes, the parking location attributes, the road attributes, parking space attributes, etc. from a geographic database 109.

In one embodiment, the system 100 can gather parking data (e.g., historical, and/or real-time data) for the area 103 (e.g., including parking locations 105) using sensors of the vehicle 101 and user devices within the vehicle 101 and/or in vicinity of the vehicle 101. The parking locations 105 can include designated parking locations, temporary parking locations, etc. A temporary parking location, for instance, can be a location which has not been designated as a parking space (e.g., a location where the vehicle 101 may be double parked). In one embodiment, such ad-hoc parking locations can be collected from delivery driver trajectories (e.g., by tracking delivery handheld devices or pads). For example, some of these temporary delivery parking locations used by delivery drivers may be illegal yet will not block other users. As another example, some other times the vehicle 101 temporarily double parks at the location, it may block another vehicle from leaving.

In one embodiment, historical parking data can include, but is not limited, to designated parking time limit data (e.g., 2-hr parking only), data indicating the occupancy/usage time periods, churn/turnover rate (e.g., how often vehicles are entering or exiting the parking locations 105 or otherwise parking within the area 103), any equivalent parking metric, etc.

In one embodiment, the parking data can be stratified according to different contextual parameters such as but not limited to time of day, day of the week, month, season, etc. In another embodiment, the system 100 can estimate a temporary parking time limit for a temporary parking location based on the parking data.

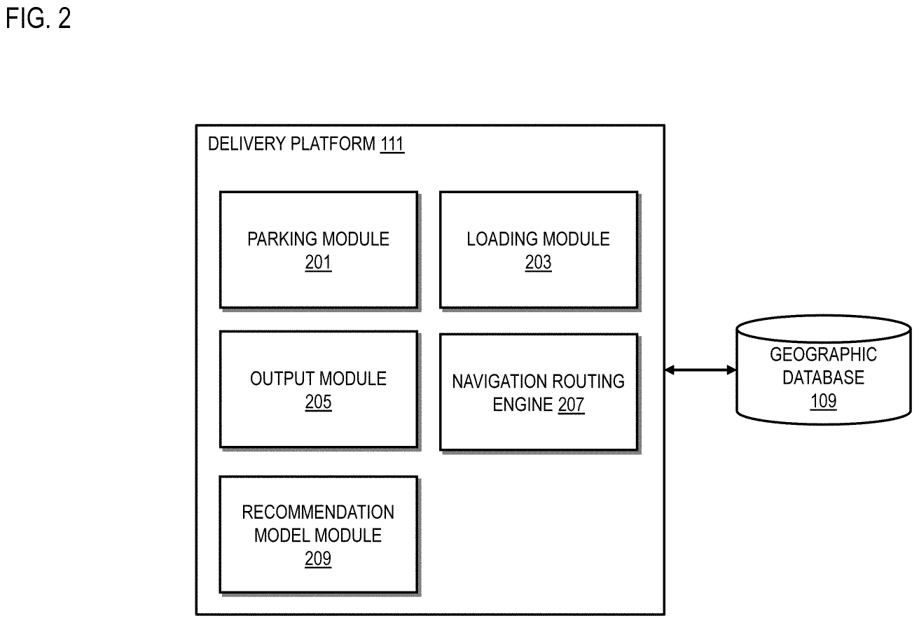

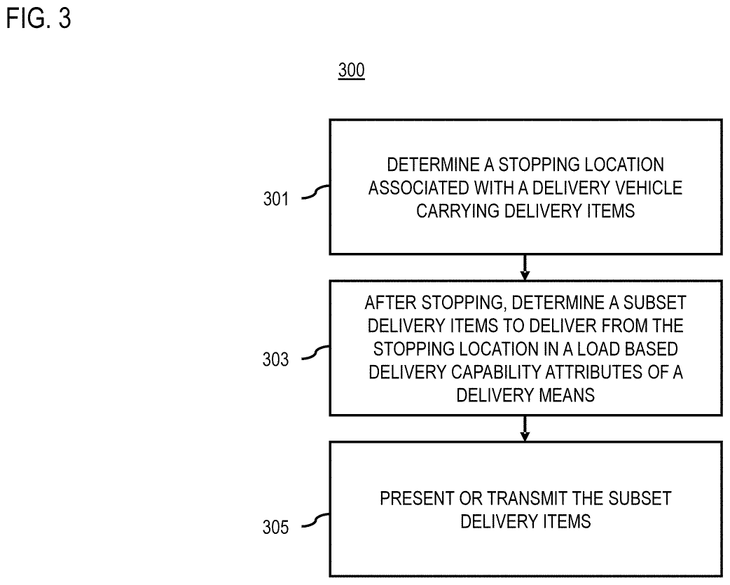

FIG. 2 is a diagram of the components of a delivery platform 111, according to one embodiment. By way of example, the delivery platform 111 includes one or more components for providing a dynamic parking and package delivery load recommendation according to the various embodiments described herein. It is contemplated that the functions of these components may be combined or performed by other components of equivalent functionality. In this embodiment, the delivery platform 111 includes a parking module 201, a loading module 203, an output module 205, a navigation routing engine 207, and a recommendation model module 209. The above presented modules and components of the delivery platform 111 can be implemented in hardware, firmware, software, or a combination thereof. Though depicted as a separate entity in FIG. 1, it is contemplated that the delivery platform 111 may be implemented as a module of any of the components of the system 100 (e.g., a component of the vehicle 101, navigation system of the vehicle 101, user equipment (UE) 113, and/or application 115 in UE 113). In another embodiment, one or more of the modules 201-209 may be implemented as a cloud based service, local service, native application, or combination thereof. The functions of these modules are discussed with respect to FIGS. 3-6 below.

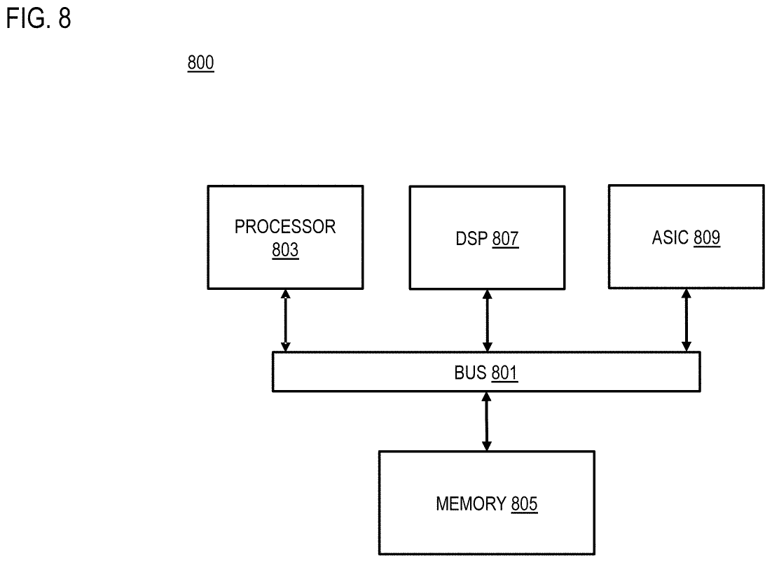

FIG. 3 is a diagram of a process for providing a dynamic parking and package delivery load recommendation for last mile delivery, according to one embodiment. In various embodiments, the delivery platform 111 and/or any of the modules 201-209 of the delivery platform 111 as shown in FIG. 2 may perform one or more portions of the process 300 and may be implemented in, for instance, a chip set including a processor and a memory as shown in FIG. 8. As such, the delivery platform 111 and/or any of the modules 201-209 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all of the illustrated steps.

In one embodiment, in step 301, the parking module 201 can determine a stopping location associated with a delivery vehicle 101. The delivery vehicle 101 carries a plurality of delivery items 107. Referring back to the delivery scenario shown in FIG. 1 within the area 103 including the plurality of parking locations 105 and designated delivery locations of the plurality delivery items 107 (e.g., packages). In one embodiment, the parking module 201 determines the best stopping location based on parking data (e.g., historical, and/or real-time data). In another embodiment, the parking module 201 determines the best stopping location by feeding various attribute data about the delivery items, the driver, the recipients, the delivery locations, the vehicle, etc. in the above-described algorithm and/or recommendation model.

In one embodiment, the parking module 201 can determine a vehicle location of the delivery vehicle, and determine one or more candidate stopping locations based on the vehicle location. The output module 205 can present the best stopping location in a map of the area 103. By way of example, the parking module 201 processes trajectory data (e.g., probe data) associated with journeys of vehicles and/or UE 113 (e.g., using big data analytics, artificial intelligence, etc.) to determine parking events of the vehicles. The parking module 201 can process the trajectory data to determine when a vehicle stopping time passing a threshold (e.g., 5 minutes) at a location. Via map matching, the parking module 201 can classify whether the location is a parking space, and then aggregate the classified parking events into parking data as a part of the parking data. When the location is mapped into a designated parking space (e.g., a marked parking spot) or an undesignated parking space (e.g., an unmarked street parking space), the relevant event data is recorded and aggregated into a database (e.g., the geographic database 109) as parking data. On the other hand, when the location cannot be mapped into a designated or undesignated parking space, the relevant event data is discarded. For example, when a vehicle is trapped in traffic, the stop is not recorded as a parking event.

In other embodiments, the parking module 201 can determine parking data, parking occupancy data, and/or churn rate data based on historical and/or real-time sensor data related to occupancy of parking spaces collected from various locations and/or POIs, such as data from motion sensors, inertia sensors, image capture sensors, proximity sensors, LIDAR (light detection and ranging) sensors, ultrasonic sensors, etc. Also, remote sensing, such as aerial or satellite photography, can be used to generate parking data directly or through machine learning (e.g., Bayes Net, Random Forest, Decision Trees, etc.).

By way of example, FIG. 4A is a diagram illustrating an example navigation user interface 400 presenting parking options, according to one embodiment. FIG. 4A shows the area 103 with different parking options, such as a spot 401 reserved for delivery parking during 8:00 am-5:00 pm, and street parking areas 403. The stopping location (e.g., the spot 401) can be selected from among the one or more candidate stopping locations.

In another embodiment, the parking module 201 can prioritize the one or more candidate stopping locations for recommending as the stopping location of the delivery vehicle based on one or more map attributes of the one or more stopping locations. The one or more map attributes classify the one or more stopping locations as a reserved delivery spot, a generic parking spot, or a non-parking spot. By way of example, the output module 205 can enhance FIG. 4A into an example navigation user interface 410 presenting parking options in conjunction with priorities in FIG. 4B, including Priority 1: the spot 401 reserved for delivery parking, Priority 2: street parking areas 403, and Priority 3: lanes on road sides 405 where there are two or more lanes on each side. In yet another embodiment, an example navigation user interface 420 presenting parking options in FIG. 4C further shows no stopping areas 407 where there is only one lane on each side thus not suitable to stop.

In one embodiment, in step 303, the loading module 203 can determine a subset of the plurality of delivery items 107 to be delivered from the stopping location by a delivery means (e.g., a deliver person, drone, etc.) of the delivery vehicle 101 in a load based, at least in part, on one or more delivery capability attributes of the delivery means. The subset of the plurality of delivery items is determined dynamically based on detecting that the delivery vehicle 101 has stopped at the stopping location.

In another embodiment, the loading module 203 can further determine one or more new delivery items to pick-up from one or more of the delivery locations of the subset of the delivery items based, at least in part, on the one or more delivery capability attributes of the delivery means.

In one embodiment, the one or more delivery capabilities include a maximum total package size, a maximum number of items, a maximum weight, or a combination thereof to be carried by the delivery means in the load. By way of example, a deliver person can be a delivery vehicle driver, a delivery assistant, etc., while a delivery drone can aerial or terrestrial (e.g., a robot). In addition, the delivery drone can be autonomous, or manually operated by the delivery person or someone else remotely.

In another embodiment, the one or more delivery capability attributes includes an availability of a delivery aid, and the loading module 203 can determine the subset of the delivery items further based on the availability of the delivery aid. By way of example, the delivery aid may be a hand truck, handcart, golf cart, bag, backpack, etc.

In one embodiment, the loading module 203 can determine one or more respective subsets of the plurality of delivery items for the one or more candidate stopping locations, such as the best stopping location, a second best stopping location (used when the best stopping location is unavailable), etc.

In one embodiment, the detecting that the delivery vehicle 101 has stopped is based on one or more sensors of the delivery vehicle 101, a device associated with the delivery vehicle 101, or a combination thereof. By way of example, the device can be a delivery driver handheld device which is also used for scanning and loading delivery items. As other examples, the device can be any user devices carried by the driver, carried by the vehicle 101, built-in the vehicle 101, etc.

In one embodiment, the loading module 203 can determine the subset of the delivery items based further on availability data for one or more recipients. By way of example, the availability data may be shared by the recipients and/or predicted by the loading module 203 that indicates a historical availability, a real-time availability, or a combination thereof of the one or more recipients to receive a delivery item.

In another embodiment, the loading module 203 can determine the subset of delivery items further based on a stopping time restriction associated with the stopping location.

In another embodiment, the loading module 203 can determine the subset of the delivery items further based on a delivery service level of the plurality of delivery items. By way of example, the delivery service level may be expedited delivery, morning delivery, delivery by end of the day, etc.

In one embodiment, in step 305, the output module 205 can provide data for presenting or transmitting the subset of the plurality of delivery items 107 as an output. By way of example, the output module 205 can present a user interface depicting the one or more respective subsets of the plurality of delivery items, the one or more candidate stopping locations, or a combination thereof. FIG. 4D is a diagram illustrating an example navigation user interface 430 presenting a delivery load scenario, according to one embodiment. FIG. 4D shows the spot 401 reserved for delivery parking is available, and the vehicle 101 stops thereat. FIG. 4D also shows a popup 431 with summary information of the subset delivery items 433 selected for the spot 401, and the highlighted symbols of the subset delivery items 433. By way of example, the summary information of the subset delivery items 433 include a total size of items: <0.7 m3, a total number of items: 7, a total weight of items: <50 kg, and all recipients are available at their designated delivery locations.

In one embodiment, the navigation routing engine 207 can generate a delivery route starting from and ending at the stopping location based on respective delivery locations of the subset of the plurality of delivery items of the load, and provide the delivery route to the output module 205. Given a list of pick-up/drop-off locations/addresses and the distances among the list of delivery locations, the navigation routing engine 207 can determine the shortest/faster/easiest possible route that visits each delivery location and returns to the parking location based a cost function. The navigation routing engine 207 can use a delivery distance, a delivery time, or a combination thereof as a cost function to generate the delivery route, using various positioning assisted navigation technologies (e.g., global navigation satellite systems (GNSS), WiFi, Bluetooth, Bluetooth low energy, 2/3/4/5G cellular signals, ultra-wideband (UWB) signals, etc.) to provide walking directions and map based on high definition outdoors and/or indoors map data retrieved from the geographic database 109. As mentioned, the system 100 can collect sensor data from the UE 113 (e.g., a delivery handheld device or a mobile user device), including moving trajectory data of the delivery means (e.g., a delivery person, drone, etc.), which can be used for generating a delivery route. A deliver person can be a driver, a driver assistant, a package handler, etc.

In another embodiment, when determining that the best stopping location becomes unavailable (e.g., taken by another vehicle, a stopping time limit expires, etc.), the parking module 201 can recommend a second best stopping location among the candidate stopping locations for the vehicle 101 based on the priority or a ranking determined in Step 301. The parking module 201 can then provide data for presenting the second best stopping location as another output to the output module 205. As mentioned, the best stopping location can be determined as unavailable using computer visioning, an input by the driver, historical availability data, or a combination thereof.

When determining that the vehicle 101 stops at the second best stopping location, the loading module 203 can select another subset of the delivery items for the driver to deliver from the second best stopping location using the same approaches discussed in conjunction with the best stopping location, such as delivery capability attributes of the delivery means, delivery timeframe data, distance data between the second best stopping location and the delivery locations of the other subset of the delivery items, stopping restriction data associated with the second best stopping location, etc. By way of example, the delivery timeframe data includes historical recipient availability data, real-time recipient availability data, or a combination thereof associated with the other subset of the delivery items. The real-time recipient availability data can be determined based on location sensor data of a mobile device of a recipient, which can be pushed to the system 100 as consented by the recipient.

FIG. 4E is a diagram illustrating an example navigation user interface 440 presenting a delivery load scenario, according to one embodiment. FIG. 4E shows the spot 401 reserved for delivery parking is unavailable, and the vehicle 101 stops at a second best stopping location 441. FIG. 4E also shows a popup 443 with summary information of the subset delivery items 445 selected for the location 441, and the highlighted symbols of the subset delivery items 445. By way of example, the summary information of the subset delivery items 445 include a total size of items: 0.7 m3, a total number of items: 4, a total weight of items: <50 kg, and 3 recipients are at home, while 1 recipient needs to leave a note or leave to a neighbor at their designated delivery locations.

In one embodiment, when determining a recipient of the subset of the delivery items becomes unavailable during a requested timeframe, the loading module 203 can exclude the respective delivery item(s) from the load while including the respective delivery location in the delivery route for the driver to leave a missed delivery notice for the recipient.

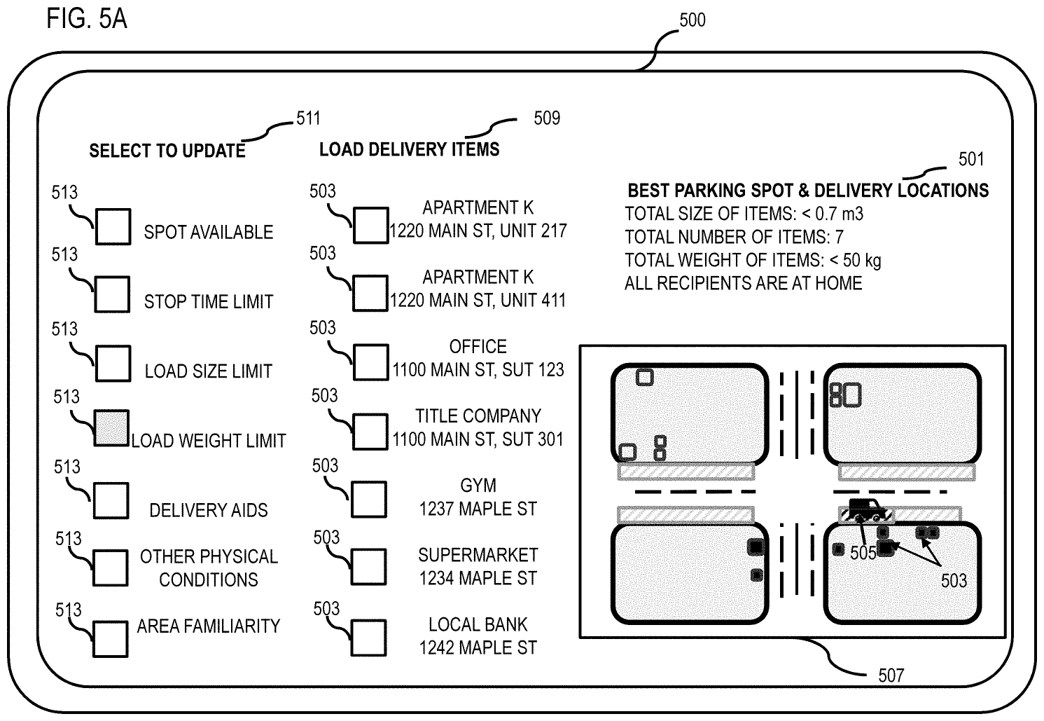

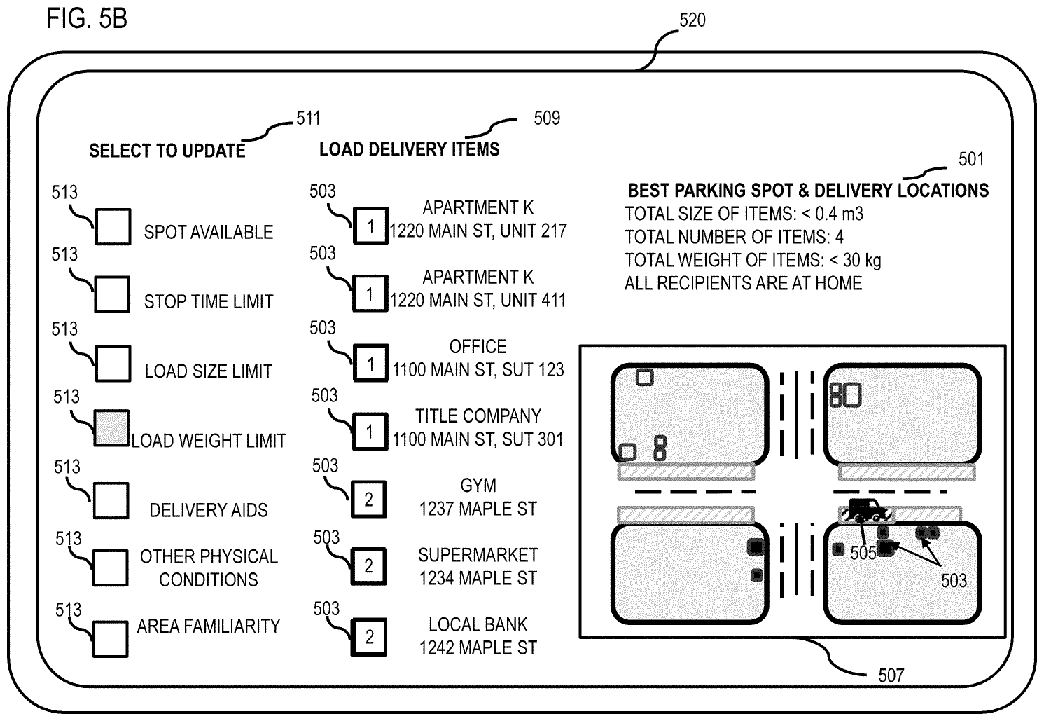

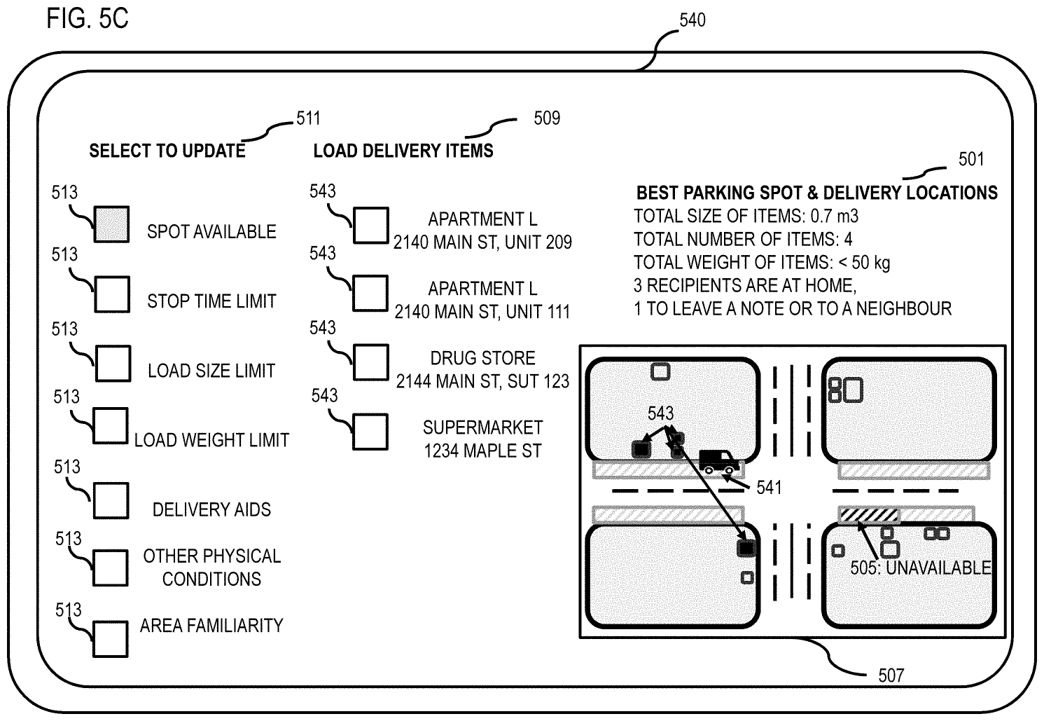

FIGS. 5A-5C are diagrams of example navigation user interfaces prompting delivery means capability updates for generating a parking and load recommendation, according to various embodiments. As the vehicle 101 carrying delivery item 107 is approaching the area 103, an example navigation user interface 500 in FIG. 5A shows a title 501 of “BEST PARKING SPOT & DELIVERY LOCATIONS” with summary information of a subset of delivery items 503 for a recommend best stopping location 505. The user interface 500 also shows a map 507 of the area 103 highlighted with the subset of delivery items 503 and the best stopping location 505. The summary information includes include a total size of items: <0.7 m3, a total number of items: 7, a total weight of items: <50 kg, and all recipients are available at their designated delivery locations.

The user interface 500 also shows a title 509 “LOAD DELIVERY ITEMS” for the driver to scan a list of delivery items 503 then hand-carry and/or load the items into a delivery aid (e.g., a hand truck). In one embodiment, when the driver uses a delivery handheld device to scan a delivery item, its address will be marched with the list, to ensure the scanned item is on the list. After all 7 delivery items on the list were scanned and loaded (as each box of the items has been highlighted as matched, the driver can start delivery. Optionally, the system 100 can provide a delivery route for the 7 delivery items 503.

The user interface 500 also shows a title 511 “SELECT TO UPDATE” for the driver to select a list of delivery attributes 513 to be updated that will affect the best stopping location and the list of delivery items. In FIG. 5A, the delivery attributes 513 includes spot availability, stop time limit, load size limit, load weight limit, delivery aids, other physical conditions, area familiarity, etc. When the driver skips updates, the driver can proceed with stopping at the best spotting location and then scanning/loading the list of items for delivery therefrom. However, when the driver selects one or more updates, the system 100 can adjust the best spotting location and the list of items for delivery.

In one embodiment, the driver selects to update “load weight limit” in an example navigation user interface 520 of FIG. 5B. The public authorities require all commercial drivers to carry a certificate of good health after passing a medical examination. However, such certificate is renewed annually or bi-annually. A deliver person can have physical and/or mental conditions anytime that can impair delivery capabilities. By way of example, the system 100 can prompt the driver to enter a new load weight limit as 30 kg, and update the summary information and the list of delivery items accordingly. Alternatively, the system 100 can use sensor data of the vehicle 101, the UE 113, etc., to determine the new load weight limit, and automatically update the best stopping location and the list of delivery items accordingly. In FIG. 5B, the summary information is updated into a total size of items: <0.4 m3, a total number of items: 4, a total weight of items: <30 kg, and all recipients are available at their designated delivery locations. In addition, the system 100 breaks the delivery items into Group 1 (e.g., the first 4 delivery items on the list) and Group 2 (e.g., the remaining 3 delivery items on the list) to meet the load weight limit of 30 kg for the driver. Optionally, the system 100 can provide two delivery routes for the two groups of delivery items. In one embodiment, the baseline driver attribute data can be collected when the driver was recruited. In another embodiment, the baseline driver attribute data is updated in a pre-trip checklist in conjunction with a delivery vehicle inspection right before leaving the office. By way of example, the driver may twist one wrist at work, thus compromising the baseline load weight limit.

In another embodiment, the driver selects to update “spot availability” in an example navigation user interface 540 of FIG. 5C. By way of example, the system 100 can determine a second best stopping location 541 among the candidate stopping locations for the vehicle 101 based on the priority or a ranking previously determined, and then determine a new list of delivery items 543 based on the new best stopping location 541. In FIG. 5C, the summary information is updated into a total size of items: 0.7 m3, a total number of items: 4, a total weight of items: <50 kg, and 3 recipients are at home, while for one recipient, a delivery note or notification needs to be left, or the parcel may be left at an alternate location (e.g., to a neighbor, work, etc.). Optionally, the system 100 can provide a delivery route for the delivery items 543.

Depending on the size of the user interface of a display, FIGS. 5A-5C may be adjust to less content for the driver to view comfortable. For example, FIGS. 5A-5C can be displayed on a tablet display. On the other hand, FIG. 5A can be split into three screens (e.g., Select to Update, Load Delivery Items, Summary and Map) for a smart phone display, or even formatted to fit on a wearable device display.

In the above-described embodiments, the delivery capability attributes of the delivery means (e.g., a delivery person, drone, etc.) can be updated manually by a driver. In other embodiments, the system 100 can use sensor data of the vehicle 101, the UE 113, etc., to determine such updates, and automatically update the best stopping location and the list of delivery items accordingly.

FIGS. 4-5 depict user interfaces provided for a driver to deliver packages. In the case of a drone, the drone can be dispatched from a central location by the system 100 without involving the vehicle 101. In another embodiment, the drone can be dispatched from the vehicle 101 by the system 100 via direct communication with the drone of a package selection and a delivery location (without involving user interfaces), once a vehicle stopping location is established. In yet another embodiment, the driver can load package(s) on the drone and release the drone via some user interfaces, while the delivery location can be set by the system 100 and/or the driver.

In one embodiment, the recommendation model module 209 may apply machine learning, artificial intelligence, deep learning, etc. on the above-referenced attribute data about the delivery items, the driver, the recipients, the delivery locations, the vehicle, etc. to identify different time-dependent delivery parking patterns of areas of similar parking attributes, delivery location attributes, driver capability attributes, etc. as clusters, and build a model for faster parking and loading recommendation for an area of interest. The attribute data may include delivery item attributes (e.g., weights, sizes, delivery locations, delivery time frames, signature requirements, etc. of items to be picked-up/dropped-off), driver attributes (e.g., load limits in terms of weights/sizes, area familiarity, delivery experience, work schedules, etc. of a driver), recipient attributes (e.g., availability data, alternate delivery locations, etc. of a delivery item recipient), delivery location attributes (e.g., operation/concierge hours, entry/exit/loading locations, ramps, stairs, elevators, distances to stopping locations, etc. associated with delivery locations), passenger attributes (e.g., preference data, with special needs or not, etc.), vehicle attributes (e.g., models, weights, sizes, delivery aids or not, maneuverability, origins/destinations, mobility graphs, etc. of the vehicle 101), parking location attributes (e.g., designated or not, paved or not, parking restrictions (e.g., handicapped parking spaces, emergency infrastructure including fire hydrants, temporary event parking limits including street fairs, festival, etc.), fee or free, churn rates, occupancy patterns, etc.), road attributes (e.g., road dimensions, shapes, directionality, lane attributes, traffic of road links near delivery locations), weather attributes (e.g., line of sight/visibility, surface slippery or not, etc.), population density, etc.

By way of example, the model is designed to solve a delivery parking location and a delivery item list query that minimizes a delivery cost function (e.g., based on a delivery distance, and/or a delivery time). The model outputs one or more top-ranked searched parking spot-delivery items combinations. In one embodiment, the model treats the query as a parametric-space search problem in which each 2D parking area is coded as a vector/matrix, and indexed by their corresponding sequence of parameter/attribute values as tokens. By way of example, the recommendation model module 209 segments a road network into a plurality of geographic areas of an identical size (i.e., a grid). For instance, each parking area may be coded as [grid unit coordinates, grid unit size], while each parking event occurred in one grid unit is codes as a vector with values of [grid unit coordinates, grid unit size, parking starting time, parking end time, day of a week, vehicle model, driver capability, delivery load weight, delivery load dimensions, delivery item list, delivery location attributes, etc.].

The recommendation model module 209 can selectively include in the vector the following as a parameter and/or a weight factor for calculating the parking score: other parking data attributes, mobility data attributes, road attributes, other vehicle attributes, driver attributes, passenger attributes, traffic attributes, weather attributes, etc.

In one embodiment, the recommendation model module 209 can cluster the areas based on the similarity of their respective parking vectors. As an example, the recommendation model module 209 can apply dynamic time warping (DTW) or other equivalent clustering algorithm to cluster the areas with similar time-dependent delivery parking occupancy patterns. The recommendation model module 209 then applies training token values to generate respective parking spot-delivery items combinations for different clusters of geographic areas, parking spots, etc.

In one embodiment, a parking spot-delivery items combination is included in a representative vector of a cluster as a representative element of the time-dependent recommendation model. When receiving actual trajectory data (e.g., probe data, sensor data, etc.) related to the vehicle 101, the recommendation model module 209 fits the actual trajectory data into the recommendation model to determine a corresponding cluster and uses one or more optimal parking locations of the cluster for recommendation. In this case, the recommendation model module 209 can apply the optimal parking locations of a similar parking patterns cluster in the model, without any knowledge of the historical parking data of the area 103 and skipping calculation for a parking spot-delivery items combination for the vehicle 101 as performed by the parking module 201 and the load module 203.

In other words, the recommendation model module 209 can predict a parking spot-delivery items combination for a new area, via matching the attributes against the representative cluster representative attributes for each cluster determined above. As such, the recommendation model module 209 can use a trained machine learning model to look for a cluster with the most similar features/attributes as the new area. Then, the system 100 makes a prediction of parking spot-delivery items combinations for the new area.

The vehicles may be manually-driven or autonomous to apply and leverage the above-discussed embodiments to minimize the delivery cost function (e.g., based on a delivery distance, and/or a delivery time). The main difference would be that autonomous vehicles can move whenever needed while considering vehicle capability attributes.

The above-mentioned embodiments dynamically process various attribute data about the delivery items, the driver, the recipients, the delivery locations, the vehicle, etc. to improve speed and quality in calculating a best spot to stop/park and what items to delivery from the stopping location. When the driver can stop at the best spot (i.e., an initially recommended stopping location), the above-mentioned embodiments present the list of items for the driver to load and deliver. When the best spot becomes unavailable (e.g., taken by another vehicle), the above-mentioned embodiments calculates the next best stopping location (i.e., a newly recommended stopping location) and a new set of items to load and deliver therefrom. Therefore, the above-mentioned embodiments dynamically determine and present information of stopping locations and package delivery plans tailored for a delivery means (e.g., a delivery person, drone, etc.) and in response to on-site parking condition changes, thereby increasing delivery efficiency.

While example embodiments described herein generally relate to delivery vehicular travel and parking along roads, example embodiments may be implemented for delivery boat travel along maritime navigational routes including dock or boat slip ducking scores, delivery drone flying along navigational aerial spaces including hovering over a roof top, a space landing, etc.

Although various embodiments are described with respect to delivery vehicles, it is contemplated that the approach described herein may be used with other vehicles, such as a private vehicle, a shared vehicle, a ride-hailing vehicle, an autonomous vehicle, etc.

Returning to FIG. 1, the system 100 includes the delivery platform 111 for performing the processes for providing a dynamic parking and package delivery load recommendation based on on-site parking availability and delivery means capability attributes according to the various embodiments described herein. As shown, the delivery platform 111 has connectivity to a parking data infrastructure comprising the parking sensors (e.g., in-ground parking sensors or equivalent) embedded in the parking locations 105, and the vehicles and/or UE 113 for collecting probe data or location traces from which parking data can also be determined. The sensors can be any type of sensor capable of detecting when a vehicle 101 parks in or leaves a parking location 105 (e.g., embedded magnetic sensors, imaging sensors, etc.), and then storing or transmitting the collected sensor data as parking data. In addition or alternatively, each vehicle 101 can be equipped with sensors (e.g., location sensors) that can also detect when the vehicle 101 parks in or leaves a parking location 105, for storage or transmission as parking data.

In one embodiment, the vehicles and/or one or more user equipment 113 associated with a vehicle 101 can act as probes traveling over a road network represented in the geographic database 109. Although the vehicle 101 is depicted as an automobile, it is contemplated that the vehicle 101 can be any type of transportation vehicle manned or unmanned (e.g., motor cycles, buses, trucks, boats, bicycles, etc.) capable of parking in a parking location 105, and the UE 113 can be associated with any of the types of vehicles or a person or thing traveling through the road network of the geographic database 109. For example, the UE 113 can be a standalone device (e.g., mobile phone, portable navigation device, wearable device, etc.) or installed/embedded in the vehicle 101. In one embodiment, the vehicle 101 and/or UE 113 may be configured with one or more sensors (such as sensors 117) for determining parking data. By way of example, the sensors 117 may include location sensors (e.g., GNSS, WiFi, Bluetooth, Bluetooth low energy, 2/3/4/5G cellular signals, UWB signals, etc.), accelerometers, compass sensors, gyroscopes, altimeters, etc. In one embodiment, the sensors 117 can also be used to detect and report status data about an operational state of the vehicle 101 to assist in determining when the vehicle 101 parks in or leaves a parking location 105. For example, a parking event may be detected when it is determined that a vehicle's is engine off, the key is outside of the car, the vehicle door is locked, and/or the like. In one embodiment, the vehicle 101 and/or UE 113 are assigned unique probe identifiers (probe ID) for use in reporting or transmitting collected probe data for determining parking data. The vehicle 101 and UE 113, for instance, are part of a probe-based system for collecting probe data for providing a dynamic parking and package delivery load recommendation based on on-site parking availability and delivery means capability attributes according to the various embodiments described herein.

In one embodiment, when a vehicle 101 and/or UE 113 (e.g., via a navigation system, navigation application 115, and/or the like) requests instructions to find parking in a given area or location, the delivery platform 111 can use the recommendation model to determine a parking spot-delivery items combination is requested. The delivery platform 111 can then provide the parking spot-delivery items combination to the vehicle 101 and/or the UE 113 for presentation in a mapping or navigation user interface. For example, the recommended parking spot-delivery items combination can provide a better estimated time of delivery (ETD) to a given area depending on various attribute data about the delivery items, the driver, the recipients, the delivery locations, the vehicle, etc. The ETD may be used as an estimated parking time which include the time to park, the time to unload delivery items off the vehicle, the time to move the delivery items to the delivery locations, the time to return to the vehicle 101, etc.

In one embodiment, as noted above, the vehicles are equipped with an embedded navigation systems or other navigation devices (e.g., a UE 113) that are capable of submitting requests for parking information (e.g., parking scores, etc.), and of guiding a driver of the vehicle 101 along a navigation route using the parking information. In one embodiment, as the driver navigates along the received route, the vehicles and/or UE 113 (e.g., via a navigation application 115) may receive real-time updates on parking data predicted for road links or street segments near a destination (e.g., parking spaces within a threshold distance of the destination).

In one embodiment, requests for a parking spot-delivery items combination can be triggered by interactions with a user interface of the vehicle 101 and/or UE 113 (e.g., an explicit request from a user or driver), or automatically when the driver or vehicle 101 approaches a target area (e.g., a set area, an inferred area, and/or any other known area

In yet another embodiment, the recommended parking spot-delivery items combinations generated for each new or updated area can be used to build or update the recommendation model and/or the geographic database 109. As discussed above, calculating parking spot-delivery items combinations can be resource intensive. As a result, many attribute data for an area stored in the recommendation model do not need to be populated, when the system 100 can use the recommendation model to estimate a parking spot-delivery items combination without having to use traditional means (e.g., analysis probe data to determine occupancy data, calculating parking spot-delivery items combinations based parking data, etc.).

In one embodiment, the vehicle 101 and/or UE 113 are configured to report probe data as probe points, which are individual data records that record telemetry data collected at a point in time. In one embodiment, a probe point can include attributes such as a heading, a speed, a time, or a combination thereof of each of the plurality of devices. At least some of these attributes can also be used as classification features. It is contemplated that any combination of these attributes or other attributes may be recorded as a probe point. As previously discussed, the vehicle 101 may include sensors for reporting measurements and/or reporting attributes. The attributes can also be any attribute normally collected by an on-board diagnostic (OBD) system of the vehicle, and available through an interface to the OBD system (e.g., OBD II interface or other similar interface). These attributes can be activation of backup sensors, steering angle, activation of brakes, etc. that can potentially be indicative of parking-related behavior.

In one embodiment, the delivery platform 111, the vehicles, and/or the UE 113 can interact with a service platform 119, one or more services 121a-121j (also collectively referred to as services 121), one or more content providers 123a-123k (also collectively referred to as content providers 123), or a combination thereof over communication network 125 to provide functions and/or services based on the recommendation model created according to the various embodiments described herein. The service platform 119, services 121, and/or content providers 123 may provide mapping, navigation, and/or other location based services to the vehicle 101 and/or UE 113.

By way of example, the UE 113 may be any mobile computer including, but not limited to, an in-vehicle navigation system, vehicle telemetry device or sensor, a personal navigation device (“PND”), a portable navigation device, a cellular telephone, a mobile phone, a personal digital assistant (“PDA”), a wearable device, a camera, a computer and/or other device that can perform navigation or location based functions, i.e., digital routing and map display. In some embodiments, it is contemplated that mobile computer can refer to a combination of devices such as a cellular telephone that is interfaced with an on-board navigation system of an autonomous vehicle or physically connected to the vehicle for serving as the navigation system.

By way of example, the delivery platform 111 may be implemented as a cloud based service, hosted solution, or the like for performing the above described functions. Alternatively, the delivery platform 111 may be directly integrated for processing data generated and/or provided by the service platform 119, services 121, content providers 123, and/or applications 115. Per this integration, the delivery platform 111 may perform client-side recommendation model building based on historical parking and delivery data.

By way of example, the communication network 125 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the delivery platform 111 communicates with other components of the system 100 using well known, new or still developing protocols. In this context, a protocol includes a set of rules defining how the network nodes within the communication network 125 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The processes described herein for providing a dynamic parking and package delivery load recommendation based on on-site parking availability and delivery means capability attributes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

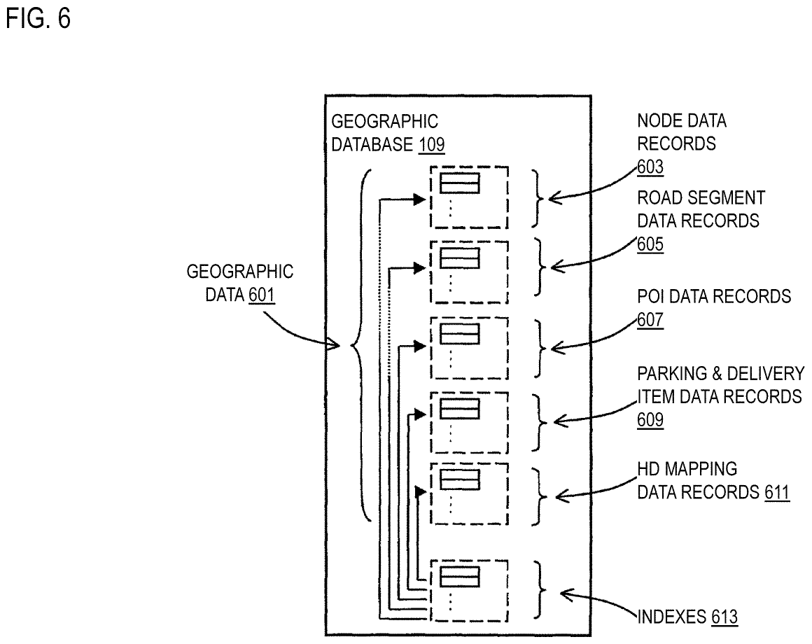

FIG. 6 is a diagram of a geographic database (such as the database 109), according to one embodiment. In one embodiment, the geographic database 109 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 109 include high resolution or high definition (HD) mapping data that provide centimeter-level or better accuracy of map features. For example, the geographic database 109 can be based on Light Detection and Ranging (LiDAR) or equivalent technology to collect billions of 3D points and model road surfaces and other map features down to the number lanes and their widths. In one embodiment, the HD mapping data (e.g., HD data records 611) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node. Also, there are no duplicated shape points, nodes, or links. Two links that connect each other have a common node. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 109 includes node data records 603, road segment or link data records 605, POI data records 607, parking and delivery items data records 609, HD mapping data records 611, and indexes 613, for example. More, fewer, or different data records can be provided. In one embodiment, additional data records (not shown) can include cartographic (“carto”) data records, routing data, and maneuver data. In one embodiment, the indexes 613 may improve the speed of data retrieval operations in the geographic database 109. In one embodiment, the indexes 613 may be used to quickly locate data without having to search every row in the geographic database 109 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, cars, and/or other entities. Alternatively, the geographic database 109 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 109 can include data about the POIs and their respective locations in the POI data records 607. The geographic database 109 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 109 can also include parking and delivery items data records 609 for storing attribute data about the delivery items, the driver, the recipients, the delivery locations, the vehicle, etc., best parking spot and delivery items combination data, training data, prediction models, annotated observations, computed featured distributions, sampling probabilities, and/or any other data generated or used by the system 100 according to the various embodiments described herein. By way of example, the parking and delivery items data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the HD mapping data records 611 model road surfaces and other map features to centimeter-level or better accuracy. The HD mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 611 are divided into spatial partitions of varying sizes to provide HD mapping data to vehicles and other end user devices with near real-time speed without overloading the available resources of the vehicles and/or devices (e.g., computational, memory, bandwidth, etc. resources).

In one embodiment, the HD mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 611.

In one embodiment, the HD mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 109 can be maintained by the content provider 121 in association with the services platform 119 (e.g., a map developer). The map developer can collect geographic data to generate and enhance the geographic database 109. There can be different ways used by the map developer to collect data. These ways can include obtaining data from other sources, such as municipalities or respective geographic authorities. In addition, the map developer can employ field personnel to travel by vehicle (e.g., vehicles and/or UE 113) along roads throughout the geographic region to observe features and/or record information about them, for example. Also, remote sensing, such as aerial or satellite photography, can be used.

The geographic database 109 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a UE 113, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a dynamic parking and package delivery load recommendation based on on-site parking availability and delivery means capability attributes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

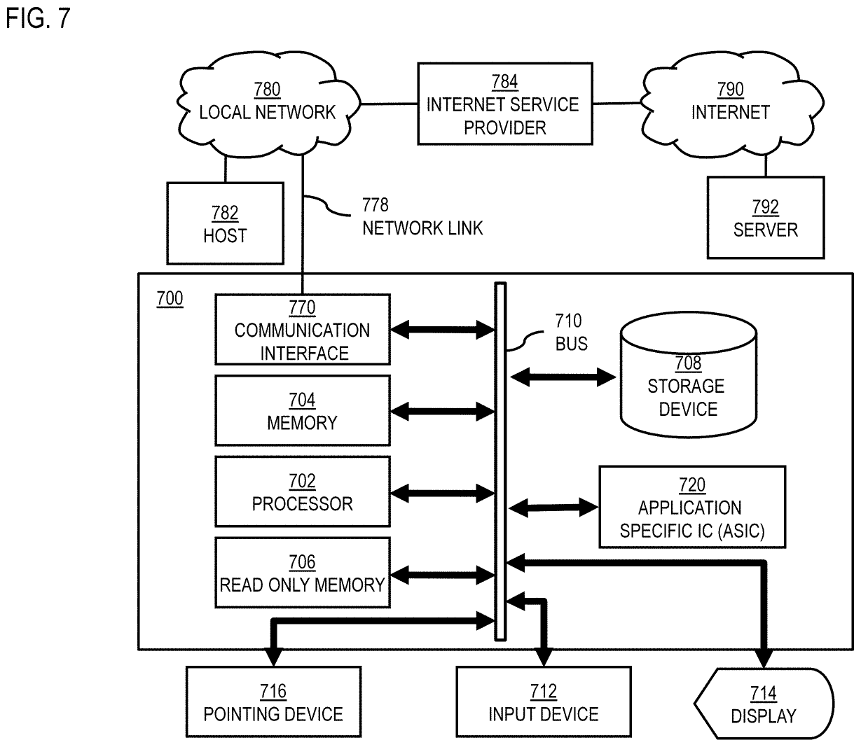

FIG. 7 illustrates a computer system 700 upon which an embodiment of the invention may be implemented. Computer system 700 is programmed (e.g., via computer program code or instructions) to provide a dynamic parking and package delivery load recommendation based on on-site parking availability and delivery means capability attributes as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing a dynamic parking and package delivery load recommendation based on on-site parking availability and delivery means capability attributes The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for providing a dynamic parking and package delivery load recommendation based on on-site parking availability and delivery means capability attributes. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk, or flash card, for storing information, including instructions, that persists even when the computer system 700 is turned off or otherwise loses power.

Information, including instructions for providing a dynamic parking and package delivery load recommendation based on on-site parking availability and delivery means capability attributes, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners, and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic, or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 125 for providing a dynamic parking and package delivery load recommendation based on on-site parking availability and delivery means capability attributes to the vehicle 101, the UE 113, or a combination thereof.

The term computer-readable medium is used herein to refer to any medium that participates in providing information to processor 702, including instructions for execution. Such a medium may take many forms, including, but not limited to, non-volatile media, volatile media, and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to provide a dynamic parking and package delivery load recommendation based on on-site parking availability and delivery means capability attributes as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide a dynamic parking and package delivery load recommendation based on on-site parking availability and delivery means capability attributes. The memory 805 also stores the data associated with or generated by the execution of the inventive steps.

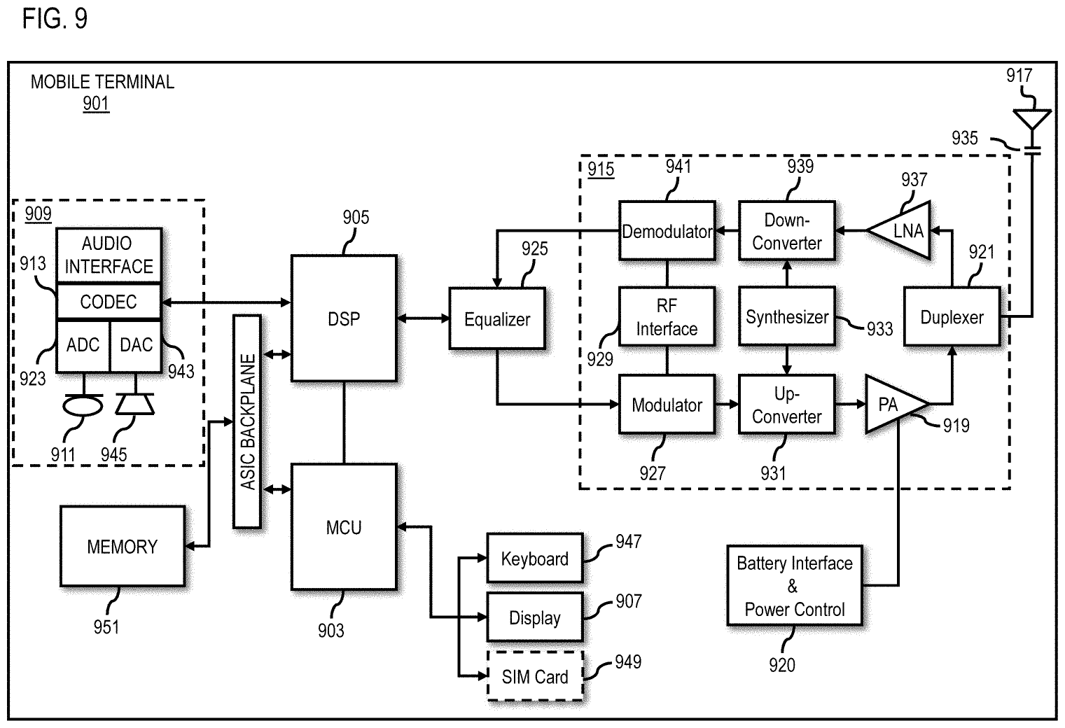

FIG. 9 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide a dynamic parking and package delivery load recommendation based on on-site parking availability and delivery means capability attributes. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method implemented by one or more processors, the method comprising:
determining a vehicle location of a delivery vehicle, wherein the delivery vehicle carries a plurality of delivery items;
determining one or more candidate stopping locations based on the vehicle location;
determining a selected stopping location from among the one or more candidate stopping locations based on processing static and dynamic data sets;
determining a subset of the plurality of delivery items to be delivered from the selected stopping location by a delivery means of the delivery vehicle in a load based, at least in part, on one or more delivery capability attributes of the delivery means, wherein the plurality of delivery items is determined dynamically based on detecting that the delivery vehicle has stopped at the selected stopping location; and
providing data for presenting or transmitting the subset of the plurality of delivery items as an output.

2. The method of claim 1, wherein the detecting that the delivery vehicle has stopped is based on one or more sensors of the delivery vehicle, a device associated with the delivery vehicle, or a combination thereof.

3. (canceled)

4. The method of claim 3, further comprising:
determining one or more respective subsets of the plurality of delivery items for the one or more candidate stopping locations; and
presenting a user interface depicting the one or more respective subsets of the plurality of delivery items, the one or more candidate stopping locations, or a combination thereof.

5. The method of claim 3, further comprising:
prioritizing the one or more candidate stopping locations for recommending as the selected stopping location of the delivery vehicle based on one or more map attributes of the one or more stopping locations,
wherein the one or more map attributes classify the one or more stopping locations as a reserved delivery spot, a generic parking spot, or a non-parking spot.

6. The method of claim 1, wherein the one or more delivery capabilities include a maximum total package size, a maximum number of items, a maximum weight, or a combination thereof to be carried by the delivery means in the load.

7. The method of claim 1, wherein the subset of the plurality of delivery items is determined based further on availability data for one or more recipient, and wherein the availability data indicates a historical availability, a real-time availability, or a combination thereof of the one or more recipients to receive a delivery item.

8. The method of claim 1, further comprising:
using a navigation routing engine to generate a delivery route starting from and ending at the selected stopping location based on respective delivery locations of the subset of the plurality of delivery items of the load; and
providing the delivery route as an output.

9. The method of claim 8, wherein the navigation routing engine uses a delivery distance, a delivery time, or a combination thereof as a cost function.

10. The method of claim 1, wherein the subset of the plurality of delivery items is further based on a stopping time restriction associated with the selected stopping location.

11. The method of claim 1, wherein the delivery means includes at least one delivery person, at least one delivery drone, or a combination thereof.

12. The method of claim 1, wherein the one or more delivery capability attributes includes an availability of a delivery aid, and wherein the subset of the plurality of the delivery items is further determined based on the availability of the delivery aid.

13. The method of claim 1, wherein the subset of the plurality of delivery items is further determined based on a delivery service level of the plurality of delivery items.

14. An apparatus comprising:
at least one processor; and
at least one memory including computer program code for one or more programs,
the at least one memory and the computer program code configured to, with the at least one processor, cause the apparatus to perform at least the following,
determine a vehicle location of a delivery vehicle, wherein the delivery vehicle carries a plurality of delivery items;
determine one or more candidate stopping locations based on the vehicle location;
determine a selected stopping location from among the one or more candidate stopping locations based on processing static and dynamic data sets;
determine a subset of the plurality of delivery items to be delivered from the selected stopping location by a delivery means of the delivery vehicle in a load based, at least in part, on one or more delivery capability attributes of the delivery means, wherein the plurality of delivery items is determined dynamically based on detecting that the delivery vehicle has stopped at the selected stopping location; and
provide data for presenting or transmitting the subset of the plurality of delivery items as an output.

15. The apparatus of claim 14, wherein the detecting that the delivery vehicle has stopped is based on one or more sensors of the delivery vehicle, a device associated with the delivery vehicle, or a combination thereof.

16. (canceled)

17. The apparatus of claim 16, wherein the apparatus is further caused to:
determine one or more respective subsets of the plurality of delivery items for the one or more candidate stopping locations; and
present a user interface depicting the one or more respective subsets of the plurality of delivery items, the one or more candidate stopping locations, or a combination thereof.

18. A non-transitory computer-readable storage medium carrying one or more sequences of one or more instructions which, when executed by one or more processors, cause an apparatus to at least perform the following steps:
determining a vehicle location of a delivery vehicle, wherein the delivery vehicle carries a plurality of delivery items;
determining one or more candidate stopping locations based on the vehicle location;
determining a selected stopping location from among the one or more candidate stopping locations associated with a delivery vehicle based on processing static and dynamic data sets;
determining a subset of the plurality of delivery items to be delivered from the selected stopping location by a delivery means of the delivery vehicle in a load based, at least in part, on one or more delivery capability attributes of the delivery means, wherein the plurality of delivery items is determined dynamically based on detecting that the delivery vehicle has stopped at the selected stopping location; and
providing data for presenting or transmitting the subset of the plurality of delivery items as an output.

19. The non-transitory computer-readable storage medium of claim 18, wherein the detecting that the delivery vehicle has stopped is based on one or more sensors of the delivery vehicle, a device associated with the delivery vehicle, or a combination thereof.

20. (canceled)

21. The method of claim 1, wherein the selected stopping location minimizes a delivery cost function based on a delivery distance and/or a delivery time.

22. The method of claim 1, wherein the static and dynamic data sets comprise delivery location data, parking location attributes, vehicle attributes, delivery item attributes, or a combination thereof.

23. The method of claim 14, wherein the selected stopping location minimizes a delivery cost function based on a delivery distance and/or a delivery time.
